(19) United States
(12) Patent Application Publication
(10) Pub. No.: US 2014/0324458 A1
(43) Pub. Date: Oct. 30, 2014

(54) Method and Apparatus for Predicting Outcome of Hearing Device Implantation

(71) Applicants: Ryan Carpenter, Cherrybrook (AU); Nicholas Feeney, Gothenburg (SE)

(72) Inventors: Ryan Carpenter, Cherrybrook (AU); Nicholas Feeney, Gothenburg (SE)

(21) Appl. No.: 13/872,692

(22) Filed: Apr. 29, 2013

(51) Int. Cl. G06Q 30/06; G06Q 50/24

(52) U.S. Cl. CPC G06Q 30/0631; G06Q 50/24
USPC 705/3

(57) ABSTRACT

A computing system provides an interface through which to receive self-characterizations of hearing performance and the like from candidates for hearing device implantation and from hearing device recipients. Provided with a candidate's pre-implantation self-characterization, the computing system searches through data to identify recipients whose entered pre-implantation self-characterizations match those of the candidate, and the computing system outputs as a predicted outcome of hearing device implantation a representation of post-implantation self-characterizations entered by the identified recipients.

### BACKGROUND

Unless otherwise indicated herein, the information described in this section is not prior art to the claims and is not admitted to be prior art by inclusion in this section.

Individuals who suffer from severe to profound hearing loss may benefit from implantation of a hearing device such as a cochlear implant, a middle-ear implant, a bone anchored hearing aid, or a brainstem implant. When considering such a solution, however, it is important to establish realistic expectations, as individual outcomes can vary greatly.

### SUMMARY

The present disclosure provides a method and corresponding system for predicting outcome of hearing device implantation in a human being.

In accordance with the disclosure, a computing system provides an interface through which individuals enter subjective self-characterizations of their hearing performance before implantation and then again after implantation, and the computing system stores that information as training data for use to help predict a post-implantation outcome for a given individual based on the individual's pre-implantation self-characterization. Through this process, the computing system may thus help to set or adjust candidate expectations regarding the outcome of hearing device implantation, and may thereby improve overall experience and satisfaction.

In one respect, for instance, the computing system may receive and store training data entered by a set of people, where the training data includes, for each person, (i) pre-implantation data entered before hearing device implantation in the person, representing pre-implantation self-characterizations of hearing performance and hearing improvement goals and (ii) post-implantation data entered after hearing device implantation in the person, representing post-implantation self-characterizations of hearing performance. Further, the computing system may receive pre-implantation data entered by a given candidate before hearing device implantation in the candidate, similarly including self-characterizations of hearing performance and hearing improvement goals. In turn, the computing system may then search through the training data to identify one or more people whose entered pre-implantation data matches the pre-implantation data entered by the candidate, and the computing system may output, as a prediction of outcome of hearing device implantation in the candidate, a representation of the post-implantation data entered by the identified one or more people.

In another respect, the computing system may receive subjective-self characterizations of hearing performance from a user by presenting the user with a sequence of pictorial representations of varying hearing-complexity and receiving input from the user selecting a pictorial representation that indicates the user's perception of their hearing performance.

For example, the computing system may present an implantation candidate with a graphical user interface that includes a progression of pictorial representations of scenarios of increasing hearing-complexity, ranging from a first pictorial representation of a least-complex hearing scenario to a last pictorial representation of a most-complex hearing scenario, and a prompt for the candidate to select any of the pictorial representations as an indication of level of hearing-difficulty of the candidate. The computing system may then receive from the candidate, in response to the prompt, a selection of one of the pictorial representations as an indication of level of hearing-difficulty of the candidate. And the computing system may then use that selection as a basis to search for and identify one or more descriptions of post-implantation hearing improvement in hearing device implant recipients. The computing system may then present another graphical user interface that depicts the one or more identified post-implantation descriptions of hearing improvement.

In still another respect, the disclosed system may include a computer readable medium having encoded thereon program instructions executable by a processing unit to carry out various functions such as those noted above. For instance, the functions may include receiving the training data and candidate data as discussed above, searching through the training data to identify one or more implant recipients whose pre-implantation self-characterizations of their hearing performance and goals for hearing improvement were similar to the pre-implantation self-characterizations of the candidate, and outputting as a predicted outcome of hearing device implantation a representation of post-implantation data entered by the identified one or more recipients.

As noted above, the computing system may be configured to provide its output to the candidate to help adjust the candidate's expectations. Further or alternatively, the computing system may be configured to provide its output to a licensed clinician who is assisting the candidate, so as to help the clinician advise the candidate on possible outcomes of hearing device implantation.

These as well as other aspects, advantages, and alternatives will become apparent to those of ordinary skill in the art by reading the following detailed description, with reference where appropriate to the accompanying drawings. Further, it should be understood that the description throughout by this document, including in this summary section, is provided by way of example only and therefore should not be viewed as limiting.

### BRIEF DESCRIPTION OF THE DRAWINGS

FIG. 1 is a simplified block diagram of a network arrangement in which the present method can be implemented.

FIG. 2 is a simplified block diagram of a server operable in the network arrangement.

FIG. 3 is a simplified block diagram of a client device operable in the network arrangement.

FIG. 4 is a flow chart depicting functions that can be carried out in accordance with the method.

FIGS. 5A, 5B, 5C, 5D, 5E, 6, 7A, 7B, 7C, and 8 are depictions of graphical user interfaces that can be presented in accordance with the method.

FIG. 9 is another flow chart depicting functions that can be carried out in accordance with the method.

FIG. 10 is a simplified depiction of a non-transitory computer readable medium encoded with instructions executable to carry out functions of the method.

FIG. 11 depicts an example graphical user interface presenting outcome prediction in accordance with the method.

### DETAILED DESCRIPTION

In a representative implementation, the present method will be carried out by a computing system that is arranged to interface directly or indirectly with users so as to receive self-characterizations of the type discussed above, to predict a post-implantation outcome based on that input, and to provide output representing that post-implantation prediction, so as to help set or adjust a candidate's expectations.

As such, the computing system may take various forms. By way of example, the computing system may comprise a standalone computer, such as a kiosk, arranged to interface directly with various users or their representatives, and having a processing unit programmed with application logic to carry out the various functions described. Alternatively, or additionally, the computing system may be network based, including a server or server cluster that is arranged to interface through one or more network connections with client devices operated by users or their representatives and similarly including a processing unit programmed with application logic to carry out the functions described.

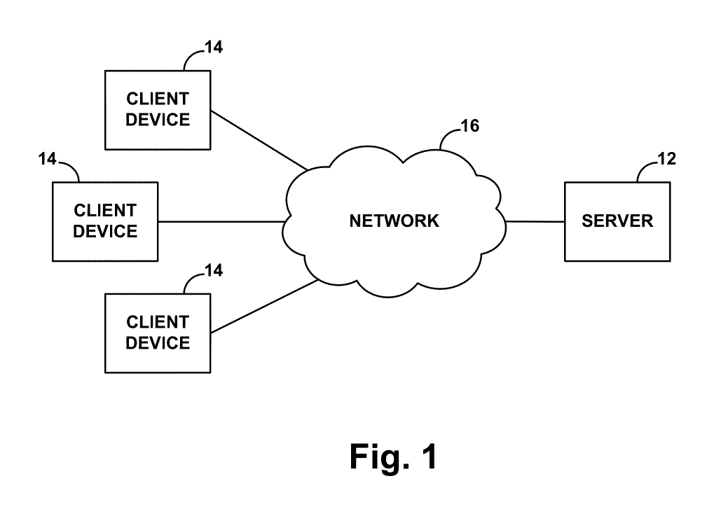

FIG. 1 is a simplified block diagram of a representative network arrangement. It should be understood, however, that this and other arrangements and processes described herein are set forth for purposes of example only, and that other arrangements and elements (e.g., machines, interfaces, functions, orders of elements, etc.) can be added or used instead and some elements may be omitted altogether. Further, those skilled in the art will appreciate that many of the elements described herein are functional entities that may be implemented as discrete components or in conjunction with other components, in any suitable combination and location, and that various disclosed functions can be implemented by any combination of hardware, firmware, and/or software, such as by one or more processors programmed to execute computer instructions for instance.

As shown in FIG. 1, the network arrangement includes a server 12 and a plurality of client devices 14, all of which sit as nodes on or are otherwise in communication with a transport network 16 such as the Internet for instance. With this arrangement, the server 12 may comprise one or more computers functioning as a web server and an application server, and the various client devices 14 may be computing devices, such as personal computers, tablet computers, mobile phones, or the like, running web browsers that are arranged to interact with the server 12 in accordance with various protocols such as Hypertext Transport Protocol (HTTP), Hypertext Markup Language (HTML), and JAVASCRIPT for instance.

As such, the client devices may be arranged to request and receive web content from the server platform, to render the content for presentation to users, to receive user input, and to transmit the input to the server platform for processing. And the server platform may be arranged to receive web content requests and user input, such as pre-implantation data and post-implantation data, from the client devices, to process the requests and input, to generate output, such as post-implantation outcome predictions, and to transmit the output to the client devices for presentation to users.

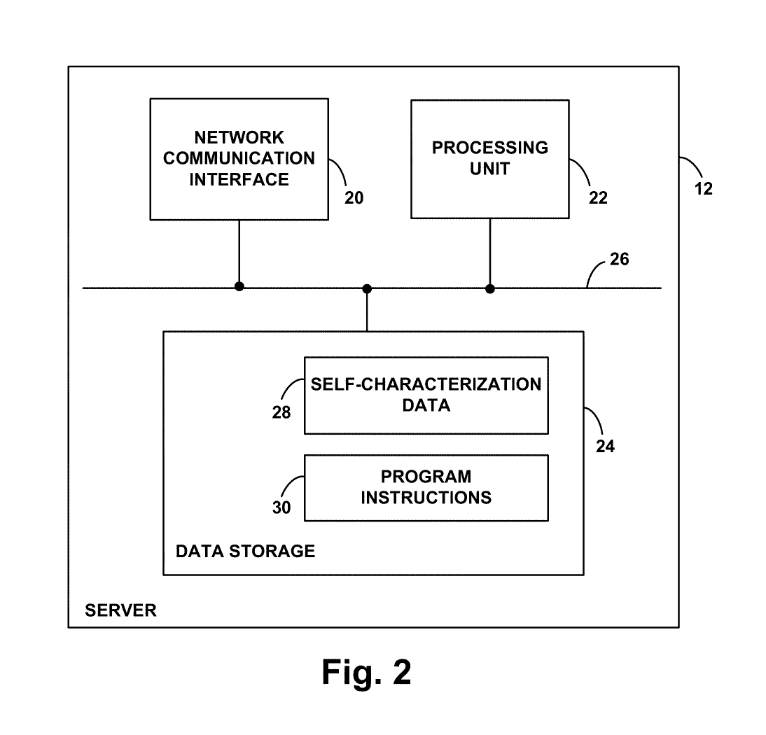

FIG. 2 is next a simplified block diagram of a representative server 12, illustrating some of the components that may be included in the server to facilitate implementation of the method. As shown by way of example in FIG. 2, the server 12 includes a network communication interface 20, a processing unit 22, and non-transitory data storage 24, all of which may be communicatively linked together by a system bus, network, or other connection mechanism 26.

Network communication interface 20 generally functions to facilitate communication with various other entities on network 16, such as client devices 14. As such, the network communication interface may include one or more network interface modules, such as Ethernet network interface modules for instance or may take any of a variety of other forms, supporting wireless and/or wired communication. Further, the network communication interface may support network layer communication, such as Internet Protocol (IP) communication.

Processing unit 22 may then comprise one or more general purpose processors (such as microprocessors) and/or one or more special purpose processors (such as application specific integrated circuits) and may be integrated in whole or in part with network communication interface 20. And data storage 24 may comprise one or more volatile and/or non-volatile storage components, such as optical, magnetic, or flash storage, and may be integrated in whole or in part with processing unit 22.

As shown, data storage 24 may hold self-characterization data 28 and program instructions 30.

The self-characterization data 28 may comprise data representing self-characterizations of hearing performance as entered by individuals both pre-implantation and post-implantation. In practice, the self-characterization data may be stored in a relational database format with records keyed to particular users and indicating for each user whether the user is a “candidate” for hearing device implantation or a “recipient” of one or more hearing device implants. For each candidate, the database may store self-characterization data entered by the candidate, segregating the data into particular types, such as data representing the candidate's perception of his or her hearing performance, data representing the candidate's goals for hearing improvement, data representing the candidate's expectations of hearing improvement, and so forth. Likewise, for each recipient, the database may store those same types of self-characterization data that were entered by each recipient when the recipient was a candidate (i.e., pre-implantation) as well as self-characterization data entered by the recipient post-implantation, similarly representing the recipient's perception of his or her hearing performance, hearing improvement, and so forth.

The program instructions 30 may then comprise code that is executable or interpretable by processing unit 22 to carry out various functions described herein. By way of example, these functions may include receiving and storing self-characterization data entered by individuals both pre-implantation and post-implantation as described above. Further, the functions may include searching through the records of recipient self-characterization data to identify recipients whose pre-implantation self-characterizations are most similar to those of a given candidate, and providing output representing the post-implantation data entered by those identified recipients, as a form of prediction of post-implantation outcome.

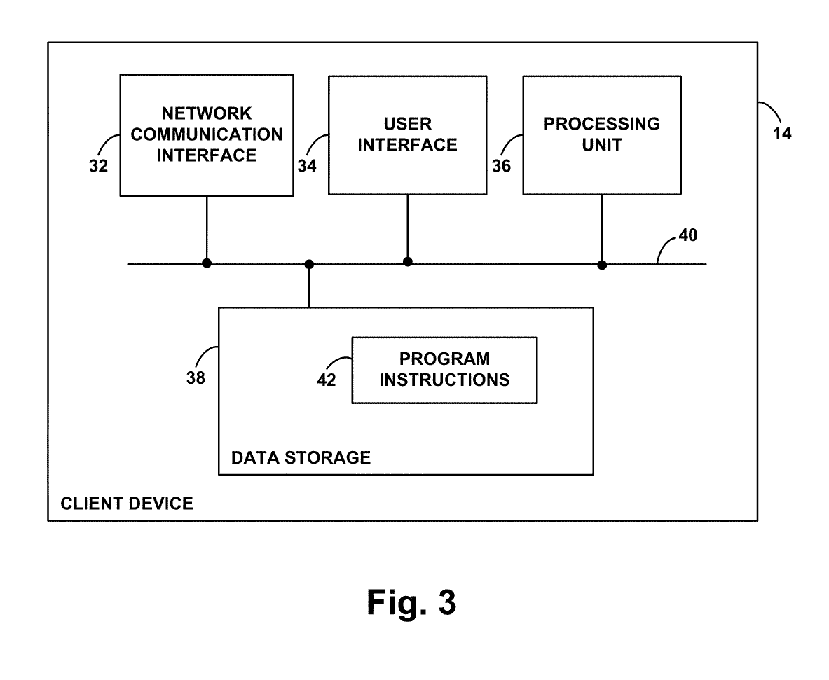

FIG. 3 is next a simplified block diagram of a representative client device 14, illustrating some of the components that may be included in a client device to facilitate implementation of the method. As shown by way of example in FIG. 3, the client device 14 includes a network communication interface 32, a user interface 34, a processing unit 36, and non-transitory data storage 38, all of which may be communicatively linked together by a system bus, network, or other connection mechanism 40.

Network communication interface 32 generally functions to facilitate communication with various other entities on network 16, such as server 12. As such, the network communication interface may include one or more network interface modules, such as Ethernet network interface modules for instance or may take any of a variety of other forms, supporting wireless and/or wired communication, and may similarly support network layer communication, such as Internet Protocol (IP) communication for instance.

In an example implementation, if the client device is a mobile communication device such as a mobile phone or wirelessly-equipped notebook or tablet computer for instance, the network communication interface 32 may comprise a wireless communication interface, such as a chipset and antenna structure arranged to engage in air interface communication with a serving base station, access point, or the like, so as to communicate in turn with entities on network 16. By way of example, such an interface may be arranged to engage in air interface communications according to protocol such as LTE, CDMA, GSM, WIFI, or BLUETOOTH.

User interface 34 then facilitates interaction with a user of the client device. As such, the user interface may include user input components such as a keypad, a mouse, a touch-pad, a touch-sensitive display screen, a microphone, and a camera. Further, the user interface may include output components such as a display screen, a loud speaker, and a headset interface. In addition, to the extent the user interface would receive and provide input through a voice interface, the user interface may include analog-digital conversion circuitry and appropriate speech-to-text and text-to-speech conversion logic.

Processing unit 36 may then comprise one or more general purpose processors (such as microprocessors) and/or one or more special purpose processors (such as application specific integrated circuits) and may be integrated in whole or in part with network communication interface 32 and/or user interface 34. And data storage 38 may comprise one or more volatile and/or non-volatile storage components, such as optical, magnetic, or flash storage, and may be integrated in whole or in part with processing unit 36.

Data storage 38 may hold program instructions 42 that are executable or interpretable by processing unit 36 to carry out various functions described herein. By way of example, the instructions may define a web browser application executable by the processing unit to request and receive web content from server 12 and to render web content for presentation by user interface 34 (e.g., as one or more graphical user interfaces on a display screen) to a user. Such graphical user interfaces may define presentation components (such as display graphics, text, images, and the like) that provide information to a user and input components (such as buttons, text boxes, hyperlinks and the like) that receive information from a user.

In practice, data storage 38 may at times also hold reference data such as user interface input provided by a user. For instance, as a user provides input into a graphical user interface, the data storage may hold that data and may then ultimately transmit that data to the server 12 (in an HTTP POST message or the like), to enable the server to store and/or process that data.

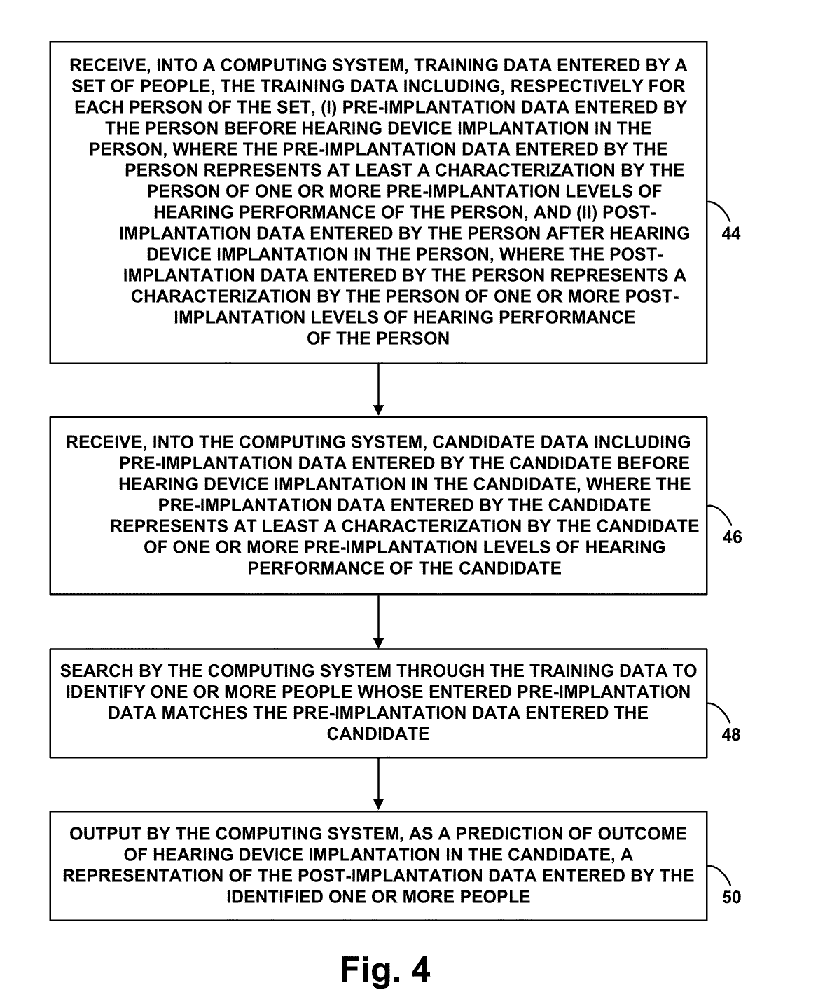

Turning next to FIG. 4, a flow chart is provided to illustrate various functions that can be carried out in accordance with the present method, to facilitate predicting outcome of hearing device implantation in a candidate.

As shown in FIG. 4, at block 44, the method involves receiving, into a computing system, training data entered by a set of people, the training data including, respectively for each person of the set, (i) pre-implantation data entered by the person before hearing device implantation in the person, where the pre-implantation data entered by the person represents at least a characterization by the person of one or more pre-implantation levels of hearing performance of the person, and (ii) post-implantation data entered by the person after hearing device implantation in the person, where the post-implantation data entered by the person represents a characterization by the person of one or more post-implantation levels of hearing performance of the person.

At block 46, the method then involves receiving, into the computing system, candidate data including pre-implantation data entered by the candidate before hearing device implantation in the candidate, where the pre-implantation data entered by the candidate represents at least a characterization by the candidate of one or more pre-implantation levels of hearing performance of the candidate.

At block 48, the method next involves searching by the computing system through the training data to identify one or more people whose entered pre-implantation data matches the pre-implantation data entered the candidate. And at block 50, the method involves outputting by the computing system, as a prediction of outcome of hearing device implantation in the candidate, a representation of the post-implantation data entered by the identified one or more people.

In line with the discussion above, the pre-implantation data entered by each individual in this process amounts to self-characterization data, in that the individual enters their own perception of their hearing performance for instance. By way of example, this self-characterization may include the individual's designation (e.g., selection) of a numeric level indicating what the individual feels their level of hearing difficulty is in particular situations. As another example, this self-characterization may include the individual's designation (e.g., selection) of a hearing-situation from a sequence of hearing-situations of increasing complexity/difficulty, indicating the level at which the individual feels the individual would be unlikely to hear adequately. Other examples are possible as well.

This subjective self-characterization input can be contrasted with an objective measure of a person's hearing performance, as may be established by an audiologist conducting scientific testing of the individual in a hearing booth or the like. As such, note that the individual's self-characterization of their hearing performance may or may not be technically correct but will optimally represent the individual's perception of their hearing performance.

Further, the pre-implantation data entered by each individual in this process may include additional self-characterizations related to the individual's hearing performance. For example, the pre-implantation data may also include the individual's characterization of one or more goals that they have for hearing improvement, such as the individual's desire to be able to listen to music of a particular type in particular situations, or the individual's goal to be able to hear people speaking in particular situations. Moreover, the pre-implantation data may include the individual's ranking of the goals in order of priority.

As another example, the pre-implantation data may also include the individual's characterizations one or more expectations that they have for hearing improvement from hearing device implantation. These expectations may be similar to the goals. By way of example, a representative expectation for hearing improvement may be an expectation that the individual's hearing level will increase by a certain percentage or that the individual will become able to hear in certain situations.

As still another example, the pre-implantation data may also include the individual's designation of other individuals with whom the individual feels they most closely associate. For instance, the computing system may present the individual with multiple character studies in the form of stories about other individual characters who had a hearing impairment and then received a hearing device implant, where each story describes how hearing performance and other issues played out for a particular character over time. And the computing system may prompt the individual to select one such character study with which the individual most closely associates, such as a character study about a character to which the individual feels he or she is most similar.

The individual's selection of such a character study may function as further self-characterization by the individual, by additionally indicating the individual's perception of his or her own hearing performance and outlook toward hearing loss. That is, the individual's choice of character study may indicate a perception that the individual is akin to the character in the selected character study. For instance, if the character in the selected study wears two hearing aids, but derives minimal benefit from them, has adult onset hearing loss, and feels that her hearing loss puts a burden on others, this selection may indicate that the individual shares one or more of these characteristics with the character in the study.

Further, the post-implantation data entered by each person in the set (i.e., each recipient) also amounts to self-characterization data, in that the person similarly enters their own perception of their hearing performance and perhaps additional data regarding how the person's hearing performance, goals and expectations have changed since hearing device implantation.

The act of the computing system searching through the training data to identify one or more people whose entered pre-implantation data matches the pre-implantation data entered by the candidate may then involve the computing system programmatically comparing the pre-implantation data entered by the candidate with pre-implantation data that was entered by various recipients, so as to identify one or more recipients whose pre-implantation data is the same as the candidate's pre-implantation data or most closely matches the candidate's pre-implantation data. Optimally, this process will thus involve comparing the self-characterization data entered by the candidate with self-characterization data that recipients had entered pre-implantation, to identify recipients who's pre-implantation self-characterization data match that of the candidate exactly or most closely.

In practice, the computing system may carry out this searching and matching function by applying any of a variety of well-known matching algorithms, such as Hidden Markov matching for instance. In the process, the computing system may score or rank various recipient records based on the extent to which the pre-implantation data in those records matches the pre-implantation data of the candidate's record. For certain pre-implantation data such as Boolean responses to particular questions, this comparison may be a simple matter of determining whether the recipient data is identical to the candidate data. For other pre-implantation data such as text entry for instance, this comparison may be more complex, involving a search for matching text, matching phrases, matching sentences, and the like. Further, the computing system may be arranged to weight various pre-implantation data more or less than other pre-implantation data. For example, the computing system may give more weight to the comparison between self-characterizations of hearing performance than to the comparison of self-characterizations of hearing improvement goals or expectations.

Upon scoring or ranking the various recipient records, the computing system may then select one or more highest scoring or top ranked recipient records as being the record(s) of recipients whose pre-implantation self-characterizations most closely match those of the candidate, and the computing system may then generate output representing the post-implantation data (e.g., post-implantation self-characterizations) entered by the identified one or more recipients. The computing system may then provide this output in the form of a new or updated a graphical user interface for presentation to the candidate or to a clinician assisting the candidate, such as by generating and returning a web page or updated web page content that includes text descriptions and/or other representations of one or more post-implantation characterizations that were entered by the identified recipients, for display by a client device.

In a representative implementation, the computing system may carry out this searching/matching and output process once the candidate has finished entering the candidate's pre-implantation data (e.g., to the extent the computing system would prompt the candidate for such entry). Further, the output may be provided to the candidate, to a clinician assisting the candidate, and/or to other authorized individuals. Optimally, providing the output to the candidate may help set or adjust the candidate's expectations regarding the results of hearing device implantation, based on the post-implantation results experienced by recipients who had pre-implantation self-characterizations similar to those of the candidate. Further, providing the output to a clinician may help the clinician in providing pre-implantation advice to the candidate, such as by assisting the clinician in understanding how recipients who had similar pre-implantation self-characterizations fared.

Further, the computing system may also carry out this searching/matching and outputting process as an intermediate step during the course of the candidate's entry of pre-implantation data and may thereby identify one or more matching recipients and present to the candidate representations of post-implantation data of the identified recipient(s) before the candidate has finished entering the candidate's pre-implantation data. Thus, the computing system may present to the candidate at least a portion of the matching training data before the candidate enters a remaining portion of the candidate's pre-implantation data. Presenting this information to the candidate before the candidate has finished entering pre-implantation self-characterizations may help the candidate reflect further and perhaps improve additional self-characterizations entered by the candidate. In turn, this potentially improved self-characterization by the candidate may help refine the computing system's searching through the training data to further identify one or more people whose entered pre-implantation data matches the pre-implantation data entered by the candidate. Consequently, this process may further refine the computing system's outcome prediction.

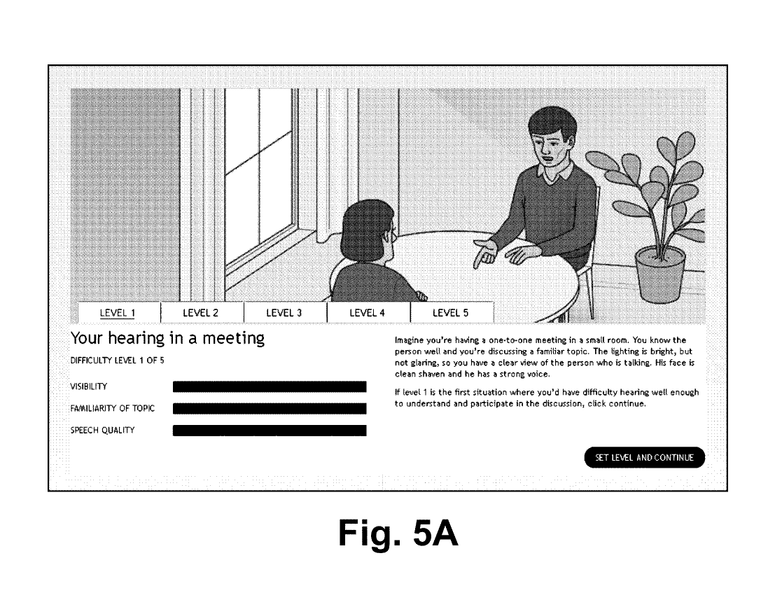

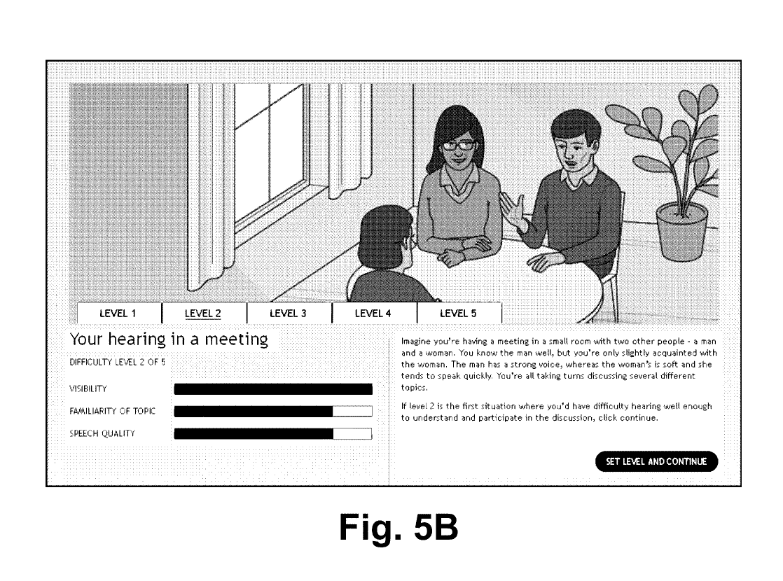

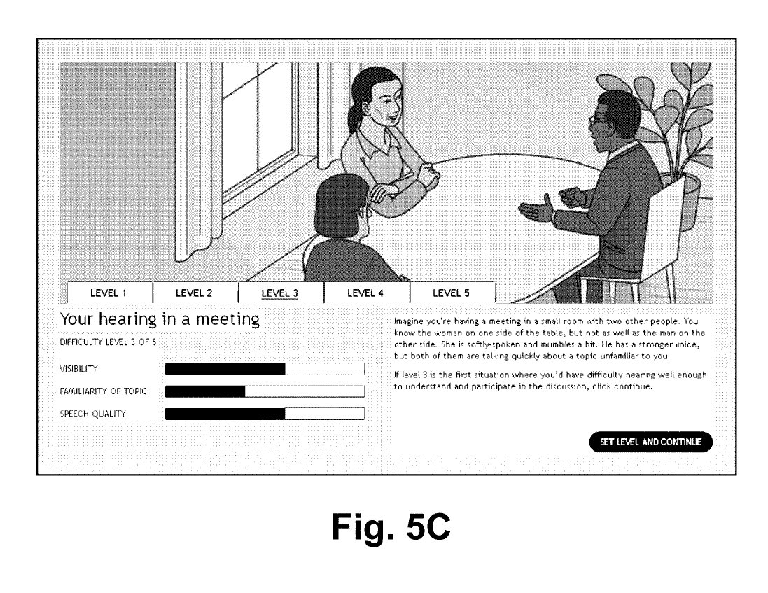

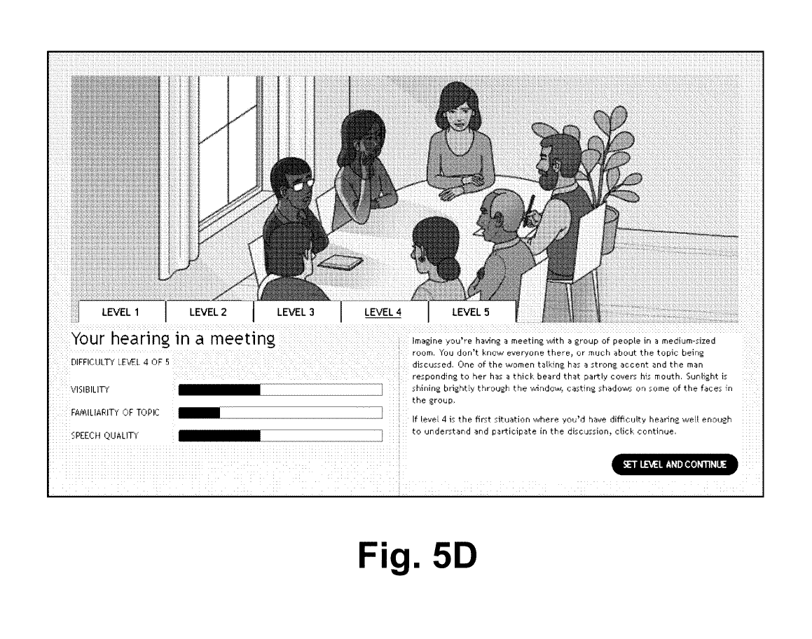

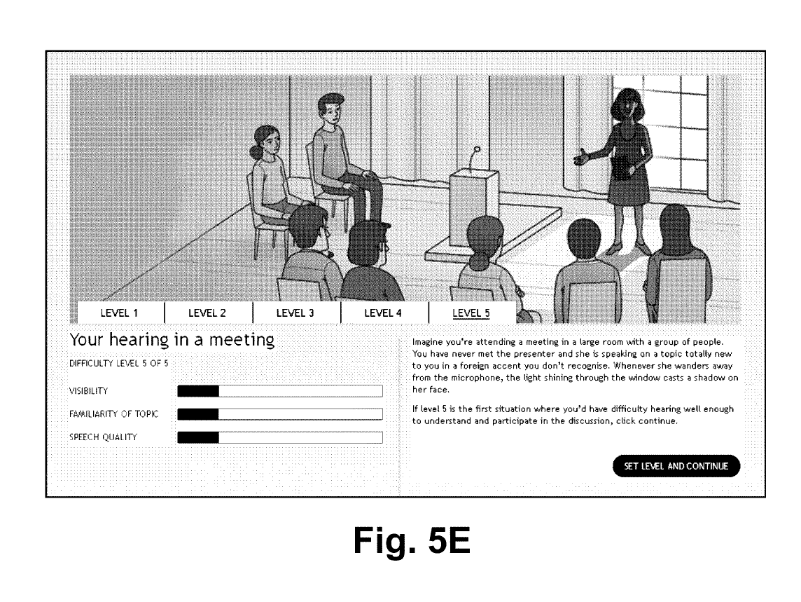

FIGS. 5-8 next provide examples of graphical user interfaces that the computing system may output for presentation to candidates and recipients, and through which the computing system may receive input from candidates and recipients, in accordance with an example implementation of the present method. In practice, the server 12 may first prompt a user (candidate or recipient) to log in or establish an account with the server, so as to associate the user with a particular database record or set of records at the server. In turn, the server may generate and provide various graphical user interfaces, and a client device 14 may render the graphical user interfaces for display to the user. Further, as the user interacts with a graphical user interface to provide input such as pre-implantation data or post-implantation data, the client device may transmit that user input to the server 12 for processing and to enable the server to provide a new or updated graphical user interface.

FIG. 5 (parts a-e) illustrates an example of graphical user interfaces that the computing system may present in order to receive user input representing one or more self-characterizations of the user's hearing performance. In this example, the graphical user interfaces depict a progression of pictorial representations of scenarios of increasing hearing-complexity, ranging from a first pictorial representation of a least-complex hearing scenario to a last pictorial representation of a most-complex hearing scenario. Further, the graphical user interfaces provide a prompt for the user to select at least one of the pictorial representations as the characterization by the user of the user's level of hearing performance. In particular, the graphical user interface prompts the user to select the pictorial representation that represents a scenario at which the user feels he or she would begin to have difficulty hearing.

Each pictorial representation in this example includes at least one picture (or perhaps a video) and, as shown, may also include an accompanying text description such as a caption or other explanation of the scenario illustrated scenario. Further, the graphical user interface is laid out to present the progression of pictorial representations in tabs labeled “Level 1” through “Level 5”, where “Level 1” represents a scenario with a lowest level of hearing-complexity and “Level 5” represents a scenario with a highest level of hearing-complexity.

In particular, as shown in FIG. 5a, Level 1 is a scenario where the user is having a one-to-one meeting in a small room, the user knows the other person well, and the discussion is of a familiar topic. Further, in this scenario, the lighting is bright, but not glaring, so the user has a clear view of the person who is talking, and the person talking has a clean shaven face and a strong voice. As shown in FIG. 5b, Level 2 is then a more complex scenario where the user is having a meeting in a small room with two other people—a man and a woman, and the user knows the man well but is only slightly acquainted with the woman. In this scenario, the man has a strong voice, but the woman's is soft and she tends to speak quickly, and all participants are taking turns discussing several different topics.

As next shown in FIG. 5c, Level 3 is a still more complex scenario where the user is having a meeting in a small room with two other people, the user knows a woman on one side of the table, but not as well as the man on the other side of the table, and the woman is softly-spoken and mumbles a bit. In this scenario, the woman is softly-spoken and mumbles a bit, the man has stronger voice, but both of them are talking quickly about a topic unfamiliar to the user. And as shown in FIG. 5d, Level 4 is a still further complex scenario where the user is having a meeting with a group of people in a medium-sized room and does not know everyone in the room or much about the topic being discussed. In this scenario, one of the women talking has a strong accent and a man responding to her has a thick beard that partly covers his mouth. Further, sunlight is shining brightly through the window, casting shadows on some of the faces in the group.

Finally, as shown in FIG. 5e, Level 5 is then an additionally complex scenario where the user is attending a meeting in a large room with a group of people, and where the user has never met the presenter and the presenter speaking on a topic totally new to the user and in a foreign accent the user does not recognize. Further, in this scenario, whenever the presenter wanders away from the microphone, the light shining through the window casts a shadow on her face.

As shown in each of FIGS. 5a-5e, the graphical user interface may instruct the user that if the depicted level is the first situation where the user would have difficulty hearing well enough to understand and participate in the discussion, the user should select the level and continue. In practice, the user would thus view part or all of the progression of pictorial representations and would select a level that represents what the user perceives as the user's level of hearing difficulty, as a self-characterization of hearing performance.

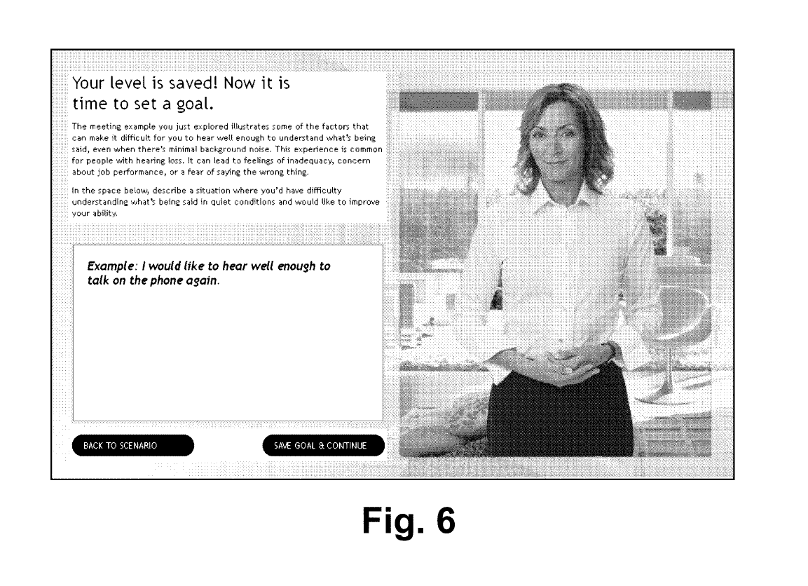

Once the user makes this selection, the computing system receives and records the user's selection, and the computing system may then present the user with a prompt such as that shown in FIG. 6. The prompt in this figure asks the user to enter a goal that the user has for hearing improvement, such as to describe a situation where the user feels he or she would have difficulty understanding what is being said and would like to improve the user's hearing performance. In response to this prompt, the user may thus type a goal for hearing improvement, and the computing system may thus receive and record that input.

The examples shown in FIGS. 5 and 6 specifically relate to the user's hearing performance in relatively quiet conditions. In practice, the computing system may additionally present graphical user interfaces that present progressions of pictorial representations for other types of conditions, the computing system may receive user input selecting a level from each such progression of pictorial representations, and the computing system may receive user input describing a goal for hearing improvement related to each level selected.

By way of example, another progression of pictorial representations may depict scenarios that are relatively noisy, such as lively social gatherings. In such a progression, Level 1 may be where the user is in a carpeted lounge, relaxing on a sofa, in early afternoon with plenty of light, where the user is part of a group and where everyone is speaking in turn, while the sound of music wafts in softly from the dining room. Level 2 may then be where the user is sitting at a table having a meal in late afternoon, with the sun still shining through the windows, with the user sitting in the middle of the table, with everyone involved in the conversation, and where soft music is playing in the background.

Level 3 may then be where the user is in the kitchen helping to prepare dinner in evening with the interior lighting bright and clear, while everyone is busy getting food ready, chopping salad, fiddling with pots and pans, and sorting out the dishes, and where everyone is involved in a lively conversation and the user can hear music playing in the background. Level 4 may then be where the user is in the family room, sitting on the sofa after dinner and where it is getting late but the room is reasonably well lit, with a lively conversation going on and people talking over one another quite a lot, and with a group of children playing on the wooden floor beside the user. And Level 5 may then be where the user is standing out late in the evening on a tiled patio that is only dimly lit and enclosed by glass, where the music is loud and everyone is chatting, joking and having a good time, and where the user is standing in the middle of everyone, trying to have a conversation as children play and run in and out.

Further, another progression of pictorial representations may depict scenarios where the user is listening to music, and the issue may be which level best reflects the situation where the user would have difficulty hearing well enough to enjoy the music. In such a progression, Level 1 may be where the user is at home playing music through a set of high quality headphones and is listening to one of his or her favorite tunes, a simple melody being played by a solo instrumentalist. Level 2 may then be where the user is at home working alone in the kitchen, a portable stereo unit is playing a simple song the user knows well, and the user finds himself or herself softly singing along with the lyrics.

Level 3 may then be where the user is at the cinema watching a dramatic scene that has a loud soundtrack featuring a big orchestra and choir. Level 4 may then be where the user is driving home, where there is a lot of road and wind noise even though the user have the windows closed, and where the user is listening to the radio playing a band's performance with a singer who is performing a song that the user has never heard before. And Level 5 may then be where the user is at a noisy outdoor music festival listening to a live band, complete with drums, keyboard, bass, electric guitar, saxophone and a singer, and where the sound is amplified, and the band is playing a song the user has never heard before.

Once the user has selected a representative level from each of these progressions of pictorial representations and has entered multiple goals for hearing improvement, such as one per selected level, the computing system may then further prompt the user to prioritize the entered goals. For instance, the computing system may present a graphical user interface that lists the entered goals and prompts the user to drag them into a priority order. The user may thereby provide additional self-characterization in the form of input designating what the user perceives as the relative importance of the entered goals.

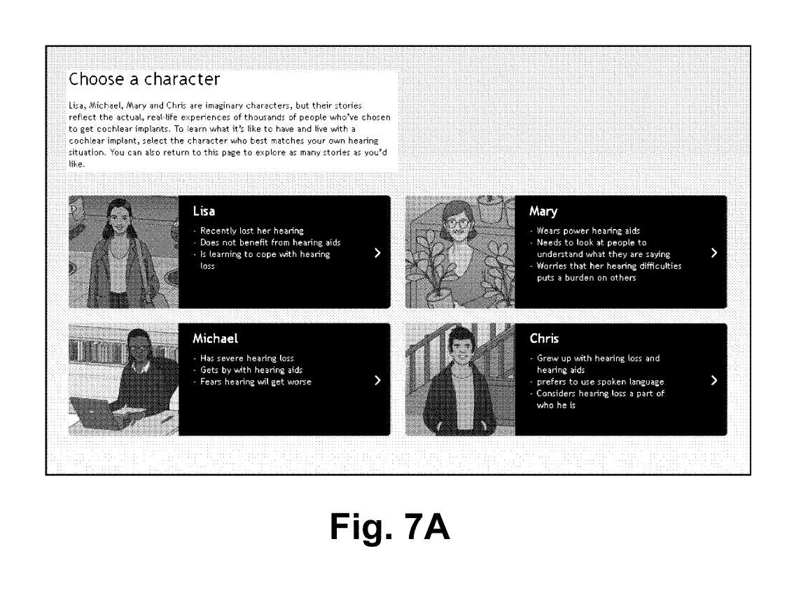

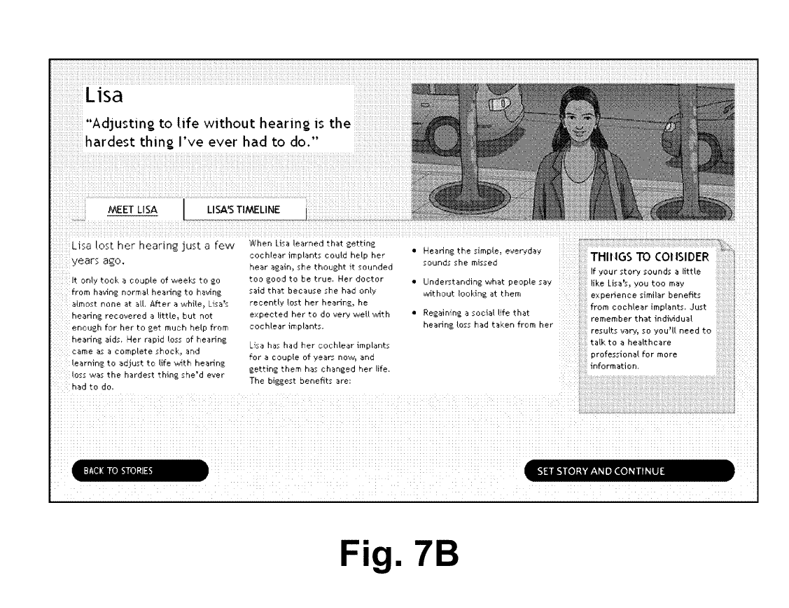

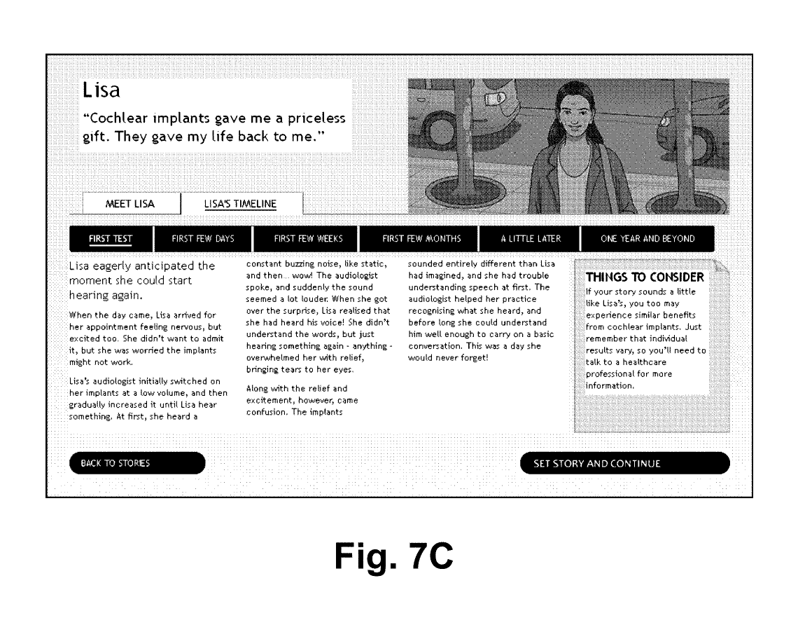

FIG. 7 (parts a-c) next illustrates another example of graphical user interfaces that the computing system may present in order to receive user input representing one or more self-characterizations of the user's hearing performance. In this example, the graphical user interfaces depict character studies of particular individuals who were hearing impaired and then received hearing device implantation, and the graphical user interface prompts the user to select one of the character studies with which the user most closely associates.

In line with the discussion above, the computing system may select these character studies from a pool of character studies, based on self-characterization data entered so far by the user. For instance, if the user has so far entered self-characterization data indicating that the user feels he or she has a particular hearing performance and/or behavior in hearing situations and has particular goals for improvement, the computing system may select character studies that involve similar pre-implantation characterizations. Advantageously, the presented character studies may thus help the user better appreciate what others who were similarly situated experienced and thus help the user establish realistic goals and expectations for hearing improvement, while also allowing the user to further self-characterize by selecting a character study with which the user feels he or she most closely associates.

As shown in FIG. 7a, the computing system may first present a graphical user interface that depicts brief summaries of the various character studies and allows the user to select and view the various character studies. FIGS. 7b and 7c then depict example graphical user interfaces depicting one of the character studies, including a description of the character pre-implantation and a description of the character's timeline post-implantation. Each such character study would be different, as outcomes would vary from character to character.

Once the user selects a character study that the user feels he or she most closely associates, the computing system may then receive that selection and record the selection as additional self-characterization data by the user.

In practice, the computing system may present still other graphical user interfaces and receive additional self-characterizations by the user. For example, the computing system may present to the user a graphical user interface that lists a series of questions about hearing performance, perhaps multiple questions for each of a series of different categories (such as understanding speech generally, understanding distance and direction of speech, and distinguishing sounds), and prompts the user to enter in response to each question what the user perceives his or her hearing performance to be and what the user expects his or her hearing performance to be at some time in the future, such as six months in the future.

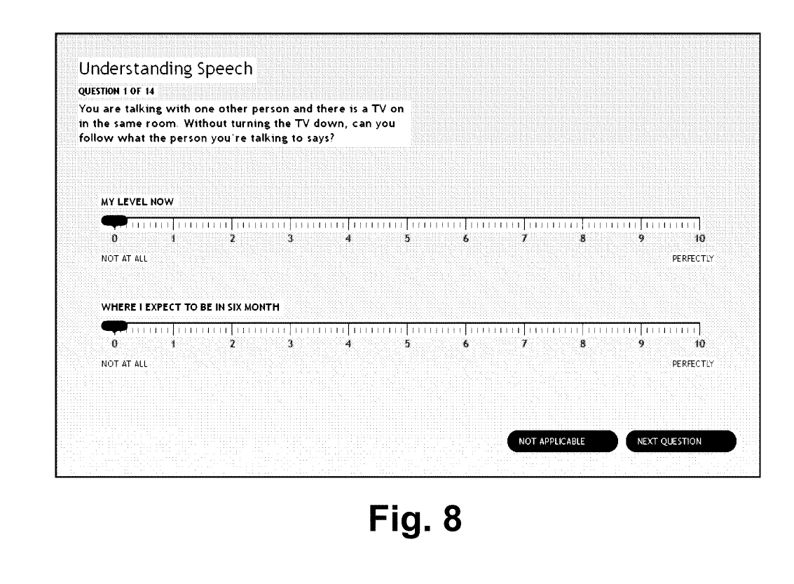

Like the level selection and goal input discussed above, some or all of these questions may describe specific hearing scenarios and may prompt the user to self-characterize their hearing level now and their expectation for what their hearing performance will be in the future. As shown in FIG. 8, for example, a graphical user interface may present a text description that states: “You are talking with one other person and there is a TV on in the same room. Without turning the TV down, can you follow what the person you're talking to says?” And the graphical user interface may present two slider controls each ranging from 0 (“not at all”) to 10 (“perfectly”), one for the user's current level and one for where the user currently expects to be in six months.

As the user proceeds through these questions, the user may thus select current and expected levels in response to each question, and the computing system may record these selections as further self-characterizations by the user.

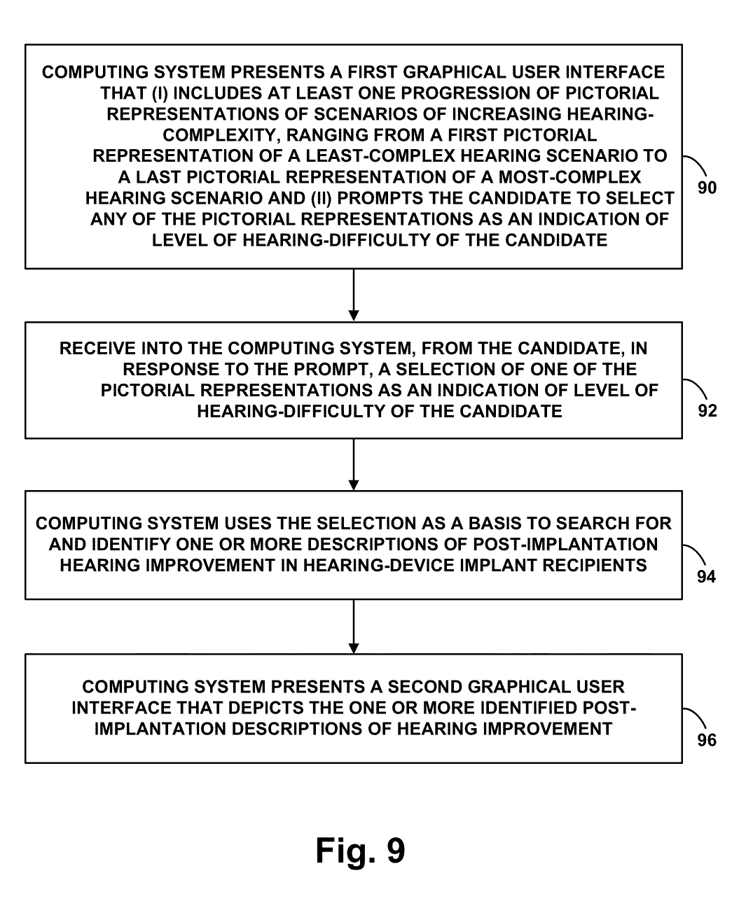

FIG. 9 is another flow chart depicting functions that can be carried out in accordance with the present method to help predict outcome of hearing device implantation in a candidate, where the computing system makes use of the pictorial representation process discussed above.

As shown in FIG. 9, at block 90, this example of the method involves a computing system presenting a first graphical user interface that (i) includes at least one progression of pictorial representations of scenarios of increasing hearing-complexity, ranging from a first pictorial representation of a least-complex hearing scenario to a last pictorial representation of a most-complex hearing scenario and (ii) prompts the candidate to select any of the pictorial representations as an indication of level of hearing-difficulty of the candidate.

At block 92, the method then involves, receiving into the computing system, from the candidate, in response to the prompt, a selection of one of the pictorial representations as an indication of level of hearing-difficulty of the candidate. And at block 94, the method involves the computing system using the selection as a basis to search for and identify one or more descriptions of post-implantation hearing improvement in hearing-device implant recipients. At block 96, the method then involves the computing system presenting a second graphical user interface that depicts the one or more identified post-implantation descriptions of hearing improvement.

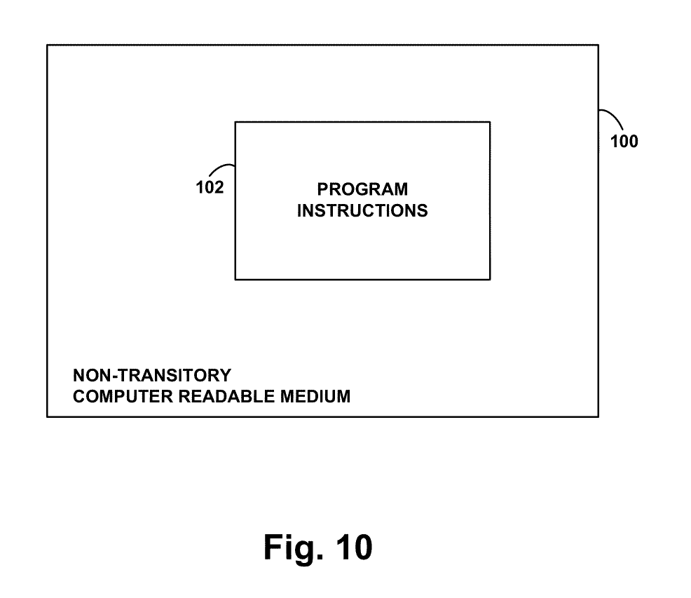

FIG. 10 next depicts a non-transitory computer readable medium 100 encoded with program instructions 102 executable by a processing unit to carry out various functions described above. This non-transitory computer readable medium may be the data storage 24 of the server 12 as discussed above or may take any of a variety of other forms, such as a magnetic or optical disc or tape, flash drive or the like, configured to be read by a computing device to facilitate processing unit execution of the program instructions.

In line with the discussion above, the program instructions 102 on the computer readable medium may be executable by the processing unit to receive training data entered by a set of people, the training data including, respectively for each person of the set, (i) pre-implantation data entered by the person before hearing device implantation in the person, where the pre-implantation data entered by the person represents a characterization by the person of one or more pre-implantation levels of hearing performance of the person, and (ii) post-implantation data entered by the person after hearing device implantation in the person, where the post-implantation data entered by the person represents a characterization by the person of one or more post-implantation levels of hearing difficulty of the person.

Further, the program instructions may be executable by the processing unit to receive candidate data including pre-implantation data entered by a candidate before hearing device implantation in the candidate, where the pre-implantation data entered by the candidate represents a characterization by the candidate of one or more pre-implantation levels of hearing performance of the candidate. And the program instructions may be executable by the processing unit to search through the training data to identify one or more people whose entered pre-implantation data matches the pre-implantation data entered the candidate and to output for display, as a prediction of outcome of hearing device implantation in the candidate, a representation of the post-implantation data entered by the identified one or more people.

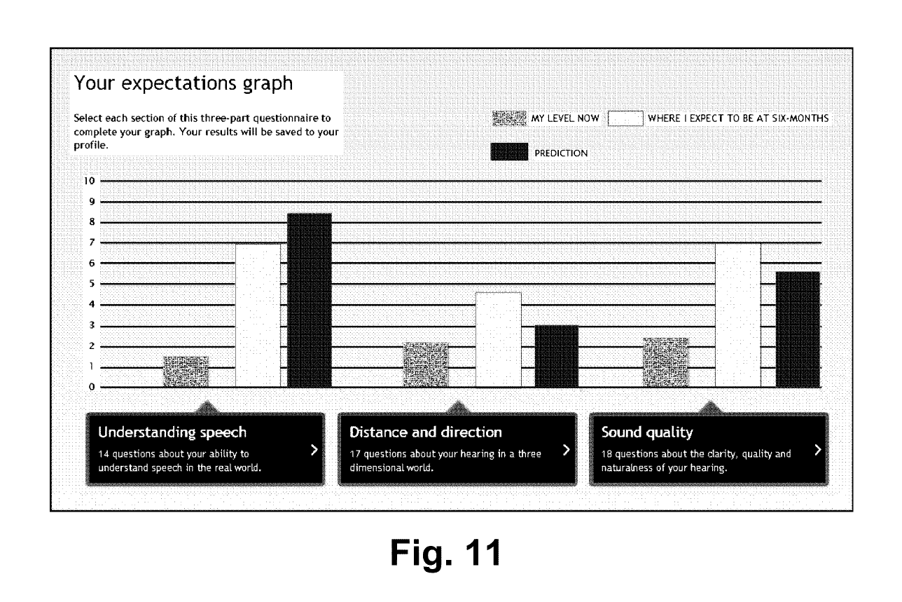

Finally, FIG. 11 provides an example of a graphical user interface that the computer system may output for presentation of the predicted outcome. In this example, the graphical user interface depicts in bar graph form, a predicted outcome alongside the user's entered level selections made in accordance for example with the interface shown in FIG. 8. In particular, each predicted outcome bar in this graphical user interface is based on post-implantation data taken from identified hearing device implant recipients. For instance, each bar may represent an average or other statistical measure of the post-implantation level data entered by the one or more identified people whose entered pre-implantation data most closely matches that entered by the user. Other examples of graphical user interfaces depicting outcome predictions in various forms are possible as well.

Exemplary embodiments have been described above. It should be understood, however, that numerous variations from the embodiments discussed are possible, while remaining within the scope of the invention.

We claim:

1. A method for predicting outcome of hearing device implantation in a candidate, the method comprising:
receiving, into a computing system, training data entered by a set of people, the training data including, respectively for each person of the set, (i) pre-implantation data entered by the person before hearing device implantation in the person, wherein the pre-implantation data entered by the person represents a characterization by the person of one or more pre-implantation levels of hearing performance of the person and a characterization by the person of one or more goals for hearing improvement in the person, and (ii) post-implantation data entered by the person after hearing device implantation in the person, wherein the post-implantation data entered by the person represents a characterization by the person of one or more post-implantation levels of hearing performance of the person;
receiving, into the computing system, candidate data including pre-implantation data entered by the candidate before hearing device implantation in the candidate, wherein the pre-implantation data entered by the candidate represents a characterization by the candidate of one or more pre-implantation levels of hearing performance of the candidate and a characterization by the candidate of one or more goals for hearing improvement in the candidate; and
searching by the computing system through the training data to identify one or more people whose entered pre-implantation data matches the pre-implantation data entered the candidate, and outputting by the computing system, as a prediction of outcome of hearing device implantation in the candidate, a representation of the post-implantation data entered by the identified one or more people.

2. The method of claim 1,
wherein the pre-implantation data entered by each person of the set further represents a characterization by the person of one or more expectations by the person for hearing improvement that will result from hearing device implantation in the person, and
wherein the pre-implantation data entered by the candidate further represents a characterization by the candidate of one or more expectations by the candidate for hearing improvement that will result from hearing device implantation in the candidate.

3. The method of claim 1, wherein the one or more goals for hearing improvement in the candidate comprises multiple goals for hearing improvement in the candidate, and wherein the characterization by the candidate of the one or more goals for hearing improvement in the candidate further comprises prioritization by the candidate of the multiple goals.

4. The method of claim 1, wherein receiving into the computing system the candidate data including the pre-implantation data entered by the candidate comprises:
outputting by the computing system, for presentation on a display, (i) at least one progression of pictorial representations of scenarios of increasing hearing-complexity, ranging from a first pictorial representation of a least-complex hearing scenario to a last pictorial representation of a most-complex hearing scenario and (ii) a prompt for the candidate to select at least one of the pictorial representations as the characterization by the candidate of the one or more pre-implantation levels of hearing performance of the candidate; and
receiving into the computing system, as at least part of the characterization by the candidate of the one or more pre-implantation levels of hearing performance of the candidate, data representing selection by the candidate of one or more or the pictorial representations in response to the prompt.

5. The method of claim 4, wherein each pictorial representation includes both a picture and an associated text description.

6. The method of claim 4, wherein the at least one progression of pictorial representations comprises:
a first progression of pictorial representations of scenarios involving hearing in quiet conditions;
a second progression of pictorial representations of scenarios involving hearing in noisy conditions; and
a third progression of pictorial representations of scenarios involving hearing music.

7. The method of claim 4, wherein the at least one progression of pictorial representations comprises multiple progressions of pictorial representations, and wherein receiving into the computing system the candidate data including the pre-implantation data entered by the candidate comprises:
receiving into the computing system, as at least part of the characterization by the candidate of the one or more pre-implantation levels of hearing performance of the candidate, data representing selection by the candidate of one or more pictorial representations respectively from each progression of pictorial representations.

8. The method of claim 4, wherein receiving into the computing system the pre-implantation data entered by each person of the set comprises:
outputting by the computing system, for presentation on a display, (i) the at least one progression of pictorial representations of scenarios of increasing hearing-complexity and (ii) a prompt for the person to select at least one of the pictorial representations as the characterization by the person of the one or more pre-implantation levels of hearing performance of the person; and
receiving into the computing system, as at least part of the characterization by the person of the one or more pre-implantation levels of hearing performance of the person, data representing selection by the person of one or more or the pictorial representations.

9. The method of claim 1, wherein hearing device implantation comprises implantation of a hearing device selected from the group consisting of a cochlear implant, a middle-ear implant, a bone anchored hearing aid, and an auditory brainstem implant.

10. The method of claim 1, wherein the computing system is accessible via a network, and wherein:
receiving the training data into the computing system comprises receiving the training data into the computing system via the network from one or more client stations; and
receiving the pre-implantation data entered by the candidate into the computing system comprises receiving the pre-implantation data via the network from one or more client stations.

11. The method of claim 1, wherein searching by the computing system through the training data to identify one or more people whose entered pre-implantation data matches the pre-implantation data entered by the candidate comprises searching by the computing system through the training data to identify one or more people whose entered pre-implantation data most closely matches the pre-implantation data entered by the candidate.

12. The method of claim 1, wherein outputting by the computing system the representation of the post-implantation data entered by the identified one or more people comprises outputting by the computing system a graphical user interface depicting the representation of the post-implantation data entered by the identified one or more people.

13. The method of claim 1, wherein outputting by the computing system the representation of the post-implantation data entered by the identified one or more people comprises outputting for presentation to the candidate the representation of the post-implantation data entered by the identified one or more people.

14. The method of claim 1, wherein outputting by the computing system the representation of the post-implantation data entered by the identified one or more people comprises outputting for presentation to a clinician the representation of the post-implantation data entered by the identified one or more people,
whereby presentation to the clinician of the representation of the post-implantation data entered by the identified one or more people may assist the clinician in providing pre-implantation advice to the candidate.

15. The method of claim 1, further comprising:
outputting, by the computing system, for presentation to the candidate, a representation of at least a portion of the received training data before the candidate enters at least a portion of the candidate data,
whereby presentation to the candidate of the representation of at least the portion of the received training data may assist the candidate in further entry of the candidate pre-implantation data, which may in turn refine the searching of the training data to identify the one or more people whose entered pre-implantation data matches the pre-implantation data entered the candidate.

16. The method of claim 15, further comprising the computing system selecting the portion of the received training data based on pre-implantation data entered by the candidate so far.

17. The method of claim 1, further comprising:
outputting, by the computing system, for presentation to the candidate, a representation of multiple character studies, wherein each character study includes a story of a respective individual having had hearing difficulty and having then received hearing device implantation,
whereby presentation to the candidate of the representation of the character studies may assist the candidate in establishing realistic goals and expectations for hearing improvement.

18. The method of claim 17, further comprising:
outputting, by the computing system, for presentation to the candidate, a prompt for the candidate to select at least one of the presented character studies with which the candidate most closely associates,
wherein the pre-implantation data entered by the candidate further represents a selection by the candidate, in response to the prompt, of at least one of the presented character studies.

19. A method for predicting outcome of hearing device implantation in a candidate, the method comprising:
presenting, by a computing system, a first graphical user interface that (i) includes at least one progression of pictorial representations of scenarios of increasing hearing-complexity, ranging from a first pictorial representation of a least-complex hearing scenario to a last pictorial representation of a most-complex hearing scenario and (ii) prompts the candidate to select any of the pictorial representations as an indication of level of hearing-difficulty of the candidate;
receiving, into the computing system, from the candidate, in response to the prompt, a selection of one of the pictorial representations as an indication of level of hearing-difficulty of the candidate;
using, by the computing system, the selection as a basis to search for and identify one or more descriptions of post-implantation hearing improvement in hearing-device implant recipients; and
presenting, by the computing system, a second graphical user interface that depicts the one or more identified post-implantation descriptions of hearing improvement.

20. The method of claim 19, wherein each pictorial representation includes both a picture and an associated text description.

21. The method of claim 19, wherein the receiving the selection from the candidate comprises receiving the selection from the candidate before hearing device implantation in the candidate.

22. The method of claim 19, wherein presenting the second graphical user interface comprises presenting the second graphical user interface to the candidate,
whereby presenting the second graphical user interface to the candidate may assist the candidate in establishing realistic expectations for hearing improvement that may result from hearing device implantation in the candidate.

23. The method of claim 19, wherein presenting the second graphical user interface comprises presenting the second graphical user interface to a clinician,
whereby presenting the second graphical user interface to the clinician may assist the clinician in advising the candidate of hearing improvement that may result from hearing device implantation in the candidate.

24. A non-transitory computer readable medium having encoded thereon program instructions executable by a processing unit to carry out functions comprising:
receiving training data entered by a set of people, the training data including, respectively for each person of the set, (i) pre-implantation data entered by the person before hearing device implantation in the person, wherein the pre-implantation data entered by the person represents a characterization by the person of one or more pre-implantation levels of hearing performance of the person, and (ii) post-implantation data entered by the person after hearing device implantation in the person, wherein the post-implantation data entered by the person represents a characterization by the person of one or more post-implantation levels of hearing difficulty of the person;
receiving candidate data including pre-implantation data entered by a candidate before hearing device implantation in the candidate, wherein the pre-implantation data entered by the candidate represents a characterization by the candidate of one or more pre-implantation levels of hearing performance of the candidate;
searching through the training data to identify one or more people whose entered pre-implantation data matches the pre-implantation data entered the candidate; and
outputting for display, as a prediction of outcome of hearing device implantation in the candidate, a representation of the post-implantation data entered by the identified one or more people.

25. The non-transitory computer readable medium of claim 24,
wherein the pre-implantation data entered by each person of the set further includes one or more characterizations by the person of one or more goals for hearing improvement in the person; and
wherein the pre-implantation data entered by the candidate further includes one or more characterizations by the candidate of one or more goals for hearing improvement in the candidate.

26. The non-transitory computer readable medium of claim 24, wherein searching through the training data to identify one or more people whose entered pre-implantation data matches the pre-implantation data entered the candidate comprises searching through the training data to identify one or more people whose entered pre-implantation data most closely matches the pre-implantation data entered by the candidate.

27. The non-transitory computer readable medium of claim 24, wherein the functions further comprise:
outputting, for presentation to the candidate, a representation of at least a portion of the received training data before the candidate enters at least a portion of the candidate data,
whereby presentation to the candidate of the representation of at least the portion of the received training data may assist the candidate in further entry of the candidate pre-implantation data, which may in turn refine the searching of the training data to identify the one or more people whose entered pre-implantation data matches the pre-implantation data entered the candidate.

28. The non-transitory computer readable medium of claim 27, further comprising:
selecting, by the computing system, the portion of the received training data based on pre-implantation data entered by the candidate so far.

29. The non-transitory computer readable medium of claim 24, wherein the functions further comprise:
outputting, for presentation to the candidate, a representation of one or more stories of individuals who had hearing difficulty and then received hearing device implantation,
whereby presentation to the candidate of the representation of one or more stories may assist the candidate in establishing realistic goals and expectations for hearing improvement.
